(19) United States
(12) Patent Application Publication
(10) Pub. No.: US 2015/0065178 A1
(43) Pub. Date: Mar. 5, 2015

(54) METHODS AND APPARATUSES FOR PROVIDING POSITIONING ASSISTANCE DATA

(71) Applicant: QUALCOMM Incorporated, San Diego, CA (US)

(72) Inventors: Stephen Joseph Beauregard, San Jose, CA (US); Sundar Raman, Fremont, CA (US)

(73) Assignee: QUALCOMM Incorporated, San Diego, CA (US)

(21) Appl. No.: 14/189,585

(22) Filed: Feb. 25, 2014

Related U.S. Application Data
(60) Provisional application No. 61/873,197, filed on Sep. 3, 2013.

(51) Int. Cl. H04W 4/02

(52) U.S. Cl. CPC H04W 4/025; H04W 4/021
USPC 455/456.6

(57) ABSTRACT

Methods and apparatuses of providing positioning assistance data are disclosed. According to aspects of the present disclosure, a venue is partitioned into a plurality of tiles, with each tile represents an area of the venue. Measurements from each tile with respect to one or more access points in the venue may be represented as one or more images. The one or more images are then processed to generate a compressed positioning assistance data of the venue. The compressed positioning assistance data may then be provided to a mobile device. Position of a mobile device may be determined using the compressed positioning assistance data of the venue.

### CROSS REFERENCE TO RELATED APPLICATIONS

This application claims the benefit of U.S. provisional application No. 61/873,197, “Methods and Apparatuses for Providing Positioning Assistance Data,” filed Sep. 3, 2013, assigned to the assignee hereof. The aforementioned United States application is hereby incorporated by reference in its entirety.

### FIELD

The present disclosure relates to the field of wireless communications. In particular, the present disclosure relates to methods and apparatuses for providing positioning assistance data to mobile devices.

### BACKGROUND

In conventional indoor positioning systems, RSSI and RTT measurements (also referred to as heatmaps) with respect to each access point within a venue may be made by a server for thousands of locations. In some situations, there may be many access points in a venue. As a result, large quantity of data may have to be sent to a mobile device in order to enable positioning and navigation applications to be performed at the mobile device. However, transmitting such large quantity of data may be inefficient as it consumes time, bandwidth, storage, and battery of the mobile device.

### SUMMARY

Methods and apparatuses of providing positioning assistance data are disclosed. According to aspects of the present disclosure, a venue is partitioned into a plurality of tiles, with each tile represents an area of the venue. Measurements from each tile with respect to one or more access points in the venue may be represented as one or more images. The one or more images are then processed to generate a compressed positioning assistance data of the venue. The compressed positioning assistance data may then be provided to a mobile device. Position of a mobile device may be determined using the compressed positioning assistance data of the venue.

In one embodiment, a method of providing positioning assistance data comprises partitioning a venue into a plurality of tiles, where each tile in the plurality of tiles represents an area of the venue, representing measurements from each tile with respect to one or more access points in the venue as one or more images, processing the one or more images to generate a compressed positioning assistance data of the venue, and providing the compressed positioning assistance data of the venue to a mobile device.

In another embodiment, an apparatus includes a positioning data assistance module and a processor, including processing logic, and the processing logic comprises logic configured to partition a venue into a plurality of tiles, where each tile in the plurality of tiles represents an area of the venue, logic configured to represent measurements from each tile with respect to one or more access points in the venue as one or more images, logic configured to process the one or more images to generate a compressed positioning assistance data of the venue, and logic configured to provide the compressed positioning assistance data of the venue to a mobile device.

In yet another embodiment, a computer program product includes non-transitory medium storing instructions for execution by one or more computer systems, and the instructions comprises instructions for partitioning a venue into a plurality of tiles, where each tile in the plurality of tiles represents an area of the venue, instructions for representing measurements from each tile with respect to one or more access points in the venue as one or more images, instructions for processing the one or more images to generate a compressed positioning assistance data of the venue, and instructions for providing the compressed positioning assistance data of the venue to a mobile device.

In yet another embodiment, an apparatus comprises means for partitioning a venue into a plurality of tiles, where each tile in the plurality of tiles represents an area of the venue, means for representing measurements from each tile with respect to one or more access points in the venue as one or more images, means for processing the one or more images to generate a compressed positioning assistance data of the venue, and means for providing the compressed positioning assistance data of the venue to a mobile device.

### BRIEF DESCRIPTION OF THE DRAWINGS

The aforementioned features and advantages of the disclosure, as well as additional features and advantages thereof, will be more clearly understandable after reading detailed descriptions of embodiments of the disclosure in conjunction with the non-limiting and non-exhaustive aspects of following drawings. Like numbers are used throughout the figures.

FIG. 1A illustrates an exemplary venue according to aspects of the present disclosure.

FIG. 1B illustrates an image representation of RSSI of WiFi signal measurements of the venue of FIG. 1A according to aspects of the present disclosure.

FIG. 1C illustrates an image representation of RTT of WiFi signal measurements of the venue of FIG. 1A according to aspects of the present disclosure.

FIG. 2A illustrates another exemplary venue according to aspects of the present disclosure.

FIG. 2B illustrates an image representation of RSSI of WiFi signal measurements of the venue of FIG. 2A according to aspects of the present disclosure.

FIG. 2C illustrates an image representation of RTT of WiFi signal measurements of the venue of FIG. 2A according to aspects of the present disclosure.

FIG. 3 illustrates an exemplary application of using assistance data provided to a mobile device in the venue of FIG. 1A according to aspects of the present disclosure.

FIG. 4 illustrates another exemplary application of using assistance data provided to a mobile device in the venue of FIG. 2A according to aspects of the present disclosure.

FIG. 5 illustrates an exemplary apparatus for providing positioning assistance data according to aspects of the present disclosure.

FIG. 6A illustrates an exemplary flow chart for implementing a method of providing positioning assistance data according to some aspects of the present disclosure. FIG. 6B illustrates exemplary methods of processing one or more images to generate a compressed positioning assistance data of a venue according to aspects of the present disclosure. FIG. 6C illustrates exemplary methods of providing the compressed positioning assistance data of a venue to a mobile device according to aspects of the present disclosure.

FIG. 7 illustrates an exemplary block diagram of a mobile device according to aspects of the present disclosure.

### DESCRIPTION OF EMBODIMENTS

Embodiments of providing positioning assistance data to mobile devices are disclosed. The following descriptions are presented to enable any person skilled in the art to make and use the disclosure. Descriptions of specific embodiments and applications are provided only as examples. Various modifications and combinations of the examples described herein will be readily apparent to those skilled in the art, and the general principles defined herein may be applied to other examples and applications without departing from the scope of the disclosure. Thus, the present disclosure is not intended to be limited to the examples described and shown, but is to be accorded the scope consistent with the principles and features disclosed herein. The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

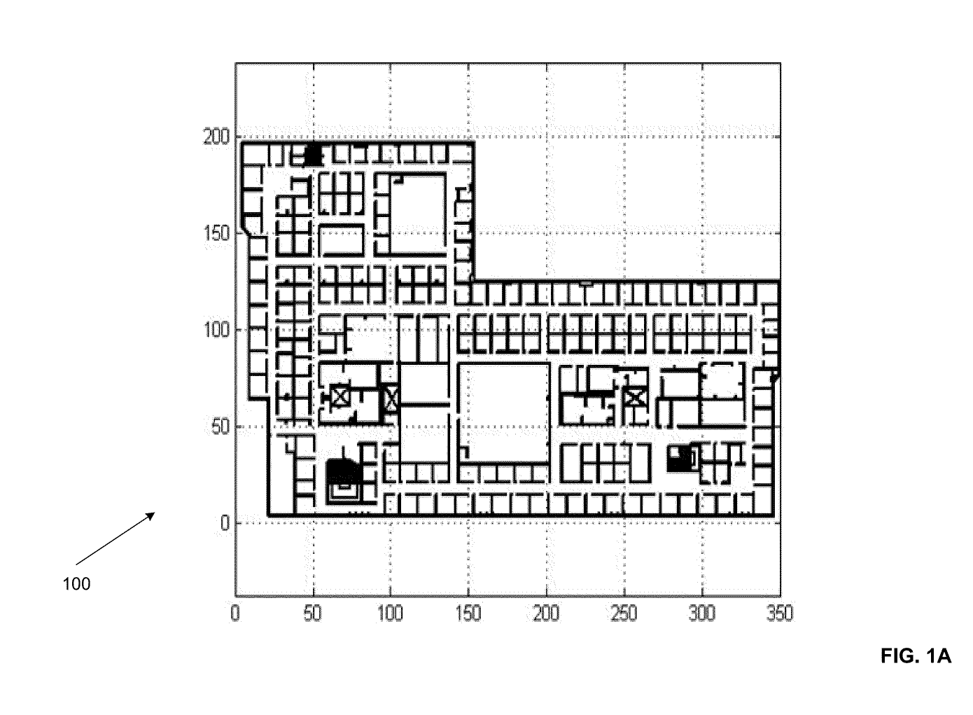

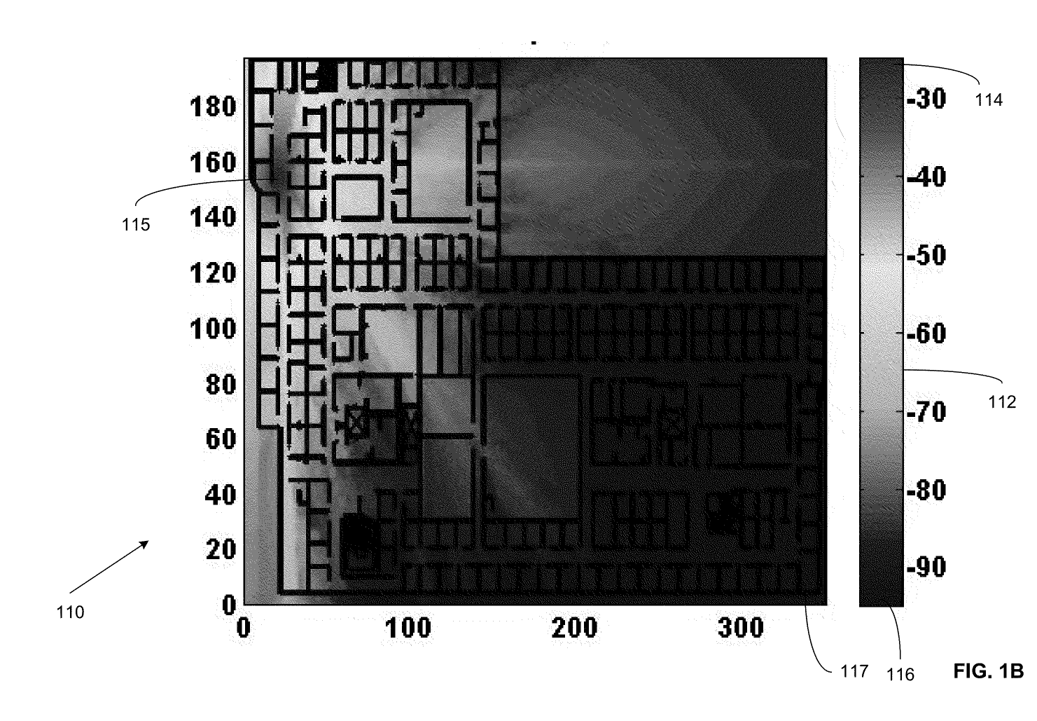

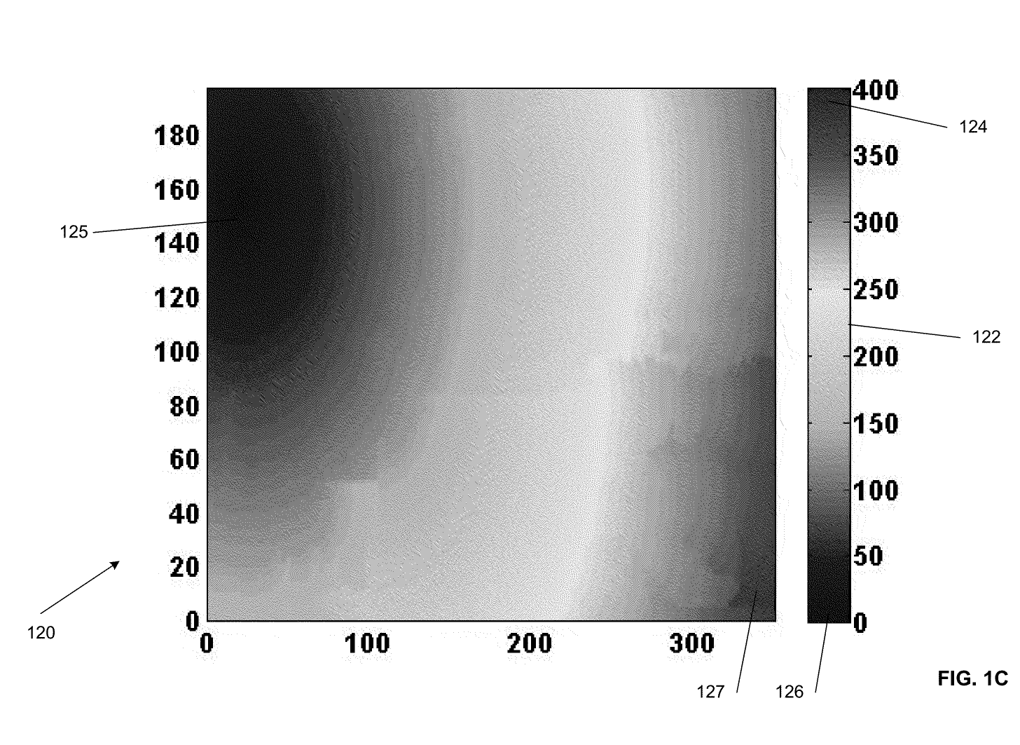

FIG. 1A illustrates an exemplary venue according to aspects of the present disclosure. In the example shown in FIG. 1A, a venue 100 may be partitioned into a plurality of tiles, for example 2 feet by 2 feet tiles, where each tile may cover a portion of the venue. The horizontal axis represents the dimension of venue 100 in feet (shown as numerals ranging from 0 to 350). The vertical axis represents the dimension of venue 100 in feet (shown as numerals ranging from 0 to 200). From each tile, observations of at least one access point device in the venue can be made; and information observed about the at least one access point device can be compiled. Note that the information observed about the at least one access point device may include, but not limited to, observation time, latitude, longitude, altitude, horizontal uncertainty, and vertical uncertainty of the at least one access point being observed. The information observed about the at least one access point device may further include MAC (media access control) address, SSID (service set identifier), RSSI (received signal strength indication), RTT (round-trip time), radio specification and frequency band. The location descriptions may include at least one of GNSS (global navigation satellite system) position measurement information and WiFi position measurement information.

According to aspects of the present disclosure, a venue may refer to an indoor and/or outdoor environment where, e.g., navigation services may be deployed. A venue may refer to a physical place or locale that may be associated with the whereabouts of an object or thing (e.g., a user, or a mobile device, etc.) according to a desired or suitable point of reference represented, for example, via geographic coordinates (e.g., latitude, longitude, etc.), a street address, a governmental jurisdiction, a postal zip code, a name, or any combination thereof, etc. Additionally or alternatively, a venue may also include references to an altitude, a time, a direction, a distance, or any combination thereof, etc., just to illustrate other possible implementations. Depending on the particular implementation, a venue may comprise, for example, various partially or substantially enclosed areas associated with an indoor environment, as described herein.

FIG. 1B illustrates an image representation of RSSI of WiFi signal measurements of the venue of FIG. 1A according to aspects of the present disclosure. As shown in FIG. 1B, RSSI of the venue 100 as measured from each tile may be represented as an image 110, which in turn includes a plurality of pixels. The horizontal axis represents the dimension of venue 100 in feet (shown as numerals 0, 100, 200, and 300). The vertical axis represents the dimension of venue 100 in feet (shown as numerals ranging from 0 to 180). Vertical strip 112 indicates measurements of RSSI in dB, shown as numerals ranging from −30 dB to −90 dB, represented by gradients of different shades of grey or color from 114 to 116, indicating RSSI signal strength received at the different locations of the venue 100. Similarly in image 110, measurements of RSSI signal strength received at the venue 100 with respect to one or more access points can be represented by gradients of different shades of grey or color range from 115 to 117.

Note that in wireless communications, RSSI is a measurement of the power present in a received radio signal. RSSI can be a radio receiver technology metric, which may usually be invisible to the user of the device containing the receiver, but may be directly known to users of wireless networking of IEEE 802.11 protocol family. RSSI measurements may be done in the intermediate frequency (IF) stage before the IF amplifier. In zero-IF systems, it can be done in the baseband signal chain, before the baseband amplifier. RSSI output may be a direct current (DC) analog level. It can also be sampled by an internal analog-to-digital converter (ADC) and the resulting codes may be available directly or via peripheral or internal processor bus. An example of a WiFi chipset is made by Qualcomm Atheros™. A Qualcomm Atheros™ based card can return an RSSI value of 0 to 127 (0x7f) with 128 (0x80) indicating an invalid value.

FIG. 1C illustrates an image representation of RTT of WiFi signal measurements of the venue of FIG. 1A according to aspects of the present disclosure. In FIG. 1C, RTT WiFi signal measurements of the venue 100 as measured from each tile may be represented as image 120, which in turn includes a plurality of pixels. The horizontal axis represents the dimension of venue 100 in feet (shown as numerals 0, 100, 200, and 300). The vertical axis represents the dimension of venue 100 in feet (shown as numerals ranging from 0 to 180). Vertical strip 122 indicates measurements of RTT in feet, shown as numerals ranging from 0 to 400 feet, represented by gradients of different shades of grey or color from 124 to 126, indicating RTT values received at the different locations of the venue 100. Similarly to the image 110 shown in FIG. 1B, measurements of RTT of the venue 100 with respect to one or more access points can be represented by gradients of different shades of grey or color range from 125 to 127. Note that in wireless communications, RTT, also known as round-trip delay time (RTD), is the length of time it may take for a signal to be sent plus the length of time it may take for an acknowledgment of that signal to be received. This time delay may include the propagation times between the two points of a signal.

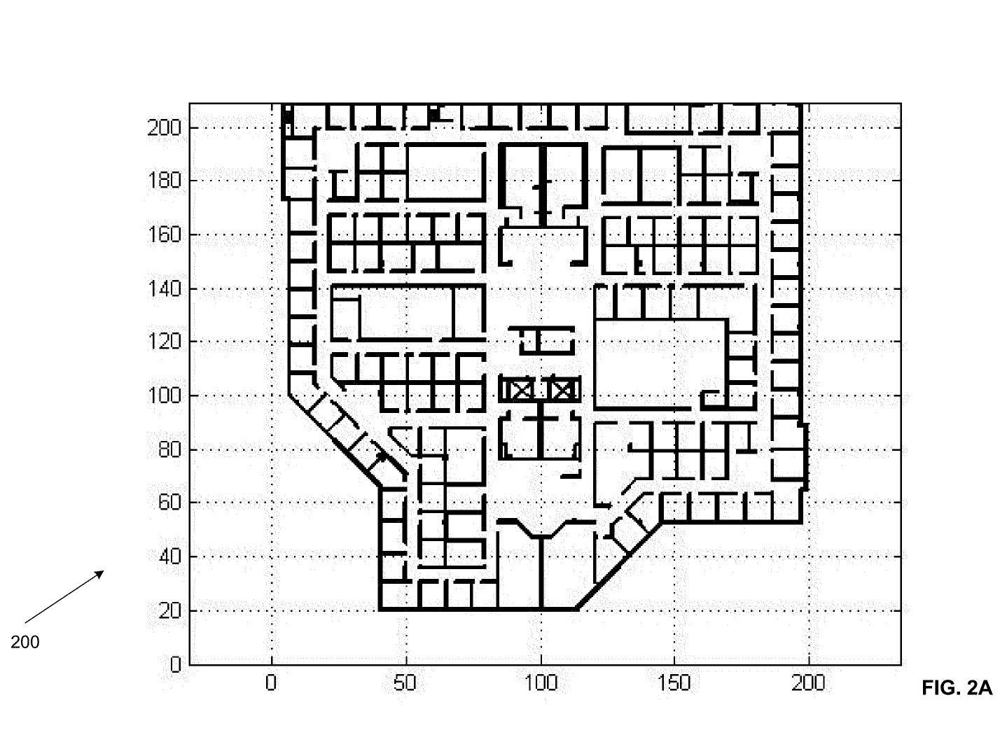

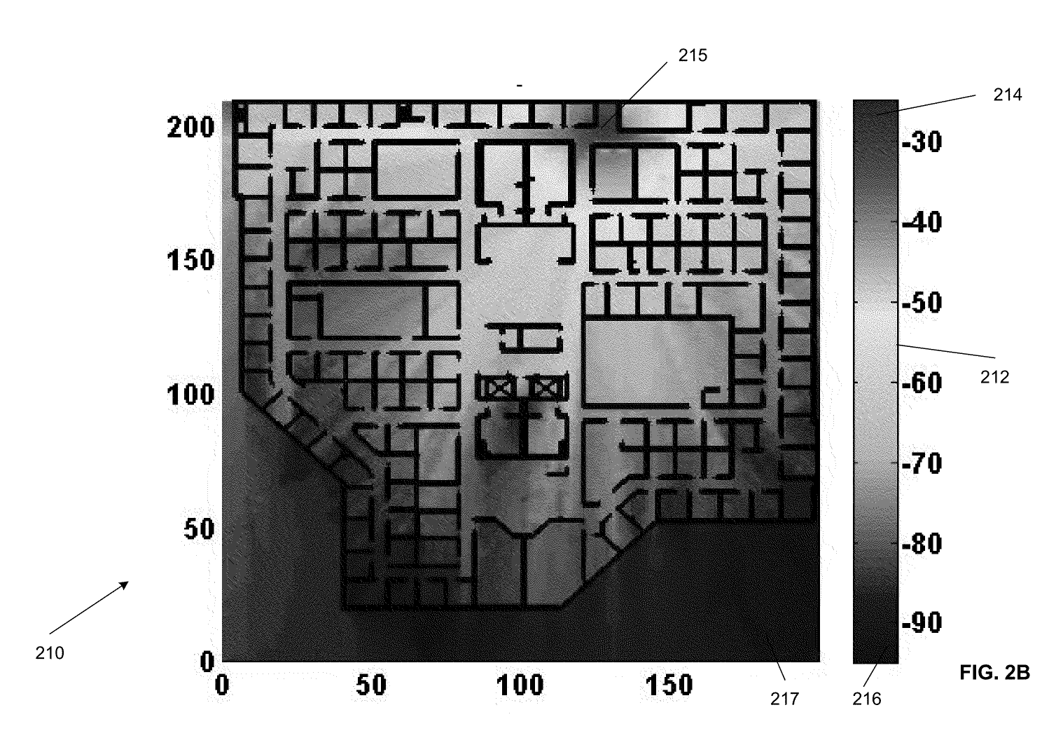

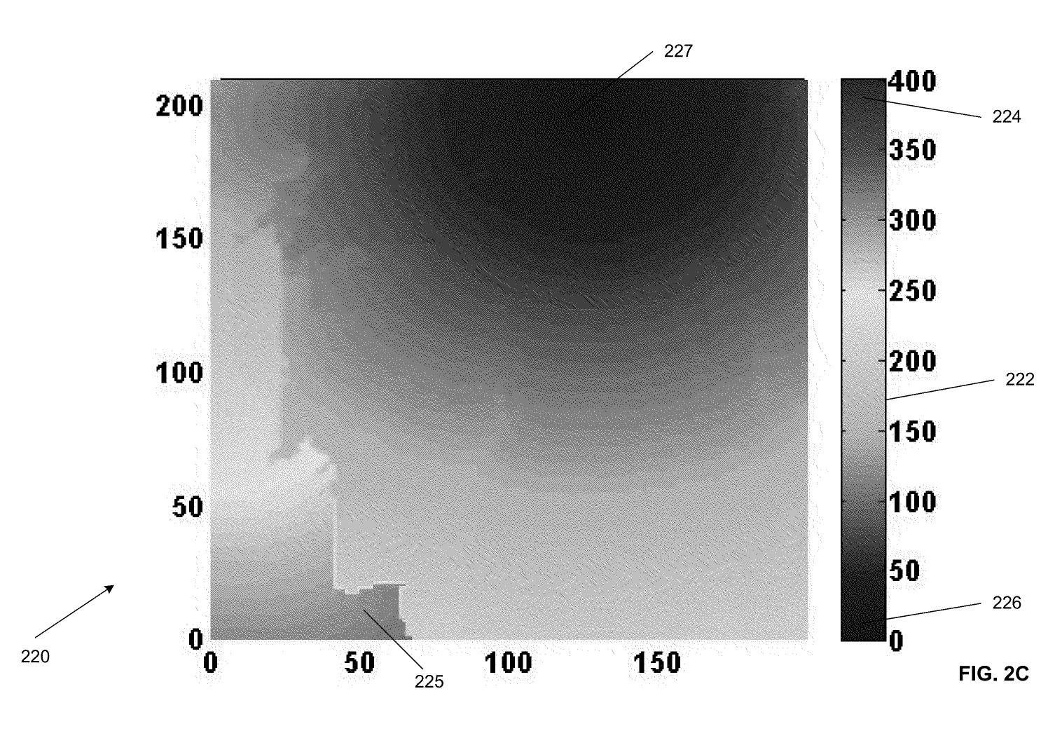

FIG. 2A illustrates another exemplary venue according to aspects of the present disclosure. In the example shown in FIG. 2A, a venue 200 may be partitioned into a plurality of tiles, similar to venue 100 shown in FIG. 1A, where each tile may cover a portion of the venue. The horizontal axis represents the dimension of venue 100 in feet (shown as numerals ranging from 0 to 200). The vertical axis represents the dimension of venue 100 in feet (shown as numerals ranging from 0 to 200). According to aspects of the present disclosure, the plurality of tiles may have different shapes, including but not limited to squares, hexagons, octagons, rectangles, triangles, rhombuses, etc. In addition, the plurality of tiles may have different sizes, such as squares of sizes 2×2, 3×3, or 4×4 square feet.

FIG. 2B illustrates an image representation of RSSI of WiFi signal measurements of the venue of FIG. 2A according to aspects of the present disclosure. In FIG. 2B, RSSI of the venue 200 as measured from each tile may be represented as an image 210, which in turn includes a plurality of pixels. The horizontal axis represents the dimension of venue 200 in feet (shown as numerals 0, 50, 100 and 150). The vertical axis represents the dimension of venue 200 in feet (shown as numerals ranging from 0 to 200). Vertical strip 212 indicates measurements of RSSI in dB, shown as numerals ranging from −30 dB to −90 dB, represented by gradients of different shades of grey or color from 214 to 216, indicating RSSI signal strength received at the different locations of the venue 200. Similarly in image 210, measurements of RSSI of the venue with respect to one or more access points can be represented by gradients of different shades of grey or color range from 215 to 217.

According to aspects of the present disclosure, a venue may provide characteristics of its environment available for access. For example, a venue may provide a schematic map of its indoor/outdoor environment, also referred to as the connectivity graph of the venue, together with locations of wireless transmitters. An interaction may be performed offline, for instance. More specifically, at an example interaction, venue may provide one or more schematic maps or other indoor/outdoor environment characteristics to a server.

FIG. 2C illustrates an image representation of RTT of WiFi signal measurements of the venue of FIG. 2A according to aspects of the present disclosure. As shown in FIG. 2C, RTT WiFi signal measurements of the venue 200 as measured from each tile may be represented as image 220, which in turn includes a plurality of pixels. The horizontal axis represents the dimension of venue 200 in feet (shown as numerals 0, 50, 100, and 150). The vertical axis represents the dimension of venue 200 in feet (shown as numerals ranging from 0 to 200). Vertical strip 222 indicates measurements of RTT in feet, shown as numerals ranging from 0 to 400 feet, represented by gradients of different shades of grey or color from 224 to 226, indicating RTT values received at the different locations of the venue 200. Similarly to the image 210 shown in FIG. 2B, measurements of RTT of the venue 200 with respect to one or more access points can be represented by gradients of different shades of grey or color range from 225 to 227.

According to aspects of the present disclosure, the images shown in FIG. 1B, FIG. 1C, FIG. 2B, and FIG. 2C may be compressed using various imaging compression techniques. In one exemplary implementation, an image may be compressed according to a predetermined down sampling ratio, by selecting some pixels and skipping some other pixels of the image according to the predetermined down sampling ratio (e.g. 1, 2, 4, 5, 10, etc.) to generate a compressed image for storage and/or transmission. In another exemplary implementation, an image may be compressed according to a predetermined quality factor or quantization level (e.g. 100%, 90%, 80%, etc.) to generate a compressed image for storage and/or transmission.

According to aspects of the present disclosure, the images shown in FIG. 1B, FIG. 1C, FIG. 2B, and FIG. 2C may be reconstructed from their corresponding compressed images using various imaging decompression techniques. In one exemplary implementation, the nearest neighbor interpolation technique may be used. The method may take the value of a pixel and assign it to the new pixels that would be created from that pixel. In another exemplary implementation, the bilinear interpolation technique may be used. The method may use the information from a pixel (for example the original pixel) and four of the pixels that touch original pixel to determine the value of the new pixels that would be created from the original pixel. The bilinear interpolation technique may use linear calculations to accomplish the above computations.

In yet another exemplary implementation, the bicubic interpolation technique may be used. The method may use the information from an original pixel and sixteen of the surrounding pixels to determine the value of the new pixels that would be created from the original pixel. The bicubic interpolation technique can be an improvement over the nearest neighbor interpolation and the bilinear interpolation methods for two reasons: (1) bicubic interpolation can use data from a larger number of pixels and (2) bicubic interpolation can use a bicubic calculation that may be more sophisticated than the calculations of the nearest neighbor interpolation and the bilinear interpolation methods.

In yet another exemplary implementation, the antialiasing technique may be used. The anti-aliasing method may be configured to minimize the appearance of aliased or jagged diagonal edges. It can remove the jagged diagonal edges and give the appearance of smoother edges and higher resolution. The anti-aliasing method can take into account how much an ideal edge overlaps adjacent pixels. The aliased edge may round up or down with no intermediate value, whereas the anti-aliased edge gives a value proportional to how much of the edge may be within each pixel. The anti-aliasing method may be adapted to detect the presence of edges and adjust to minimize aliasing while still retaining edge sharpness. Since an anti-aliased edge may contain information about that edge's location at higher resolutions, it may be partially reconstructed the edge during the process of enlargement.

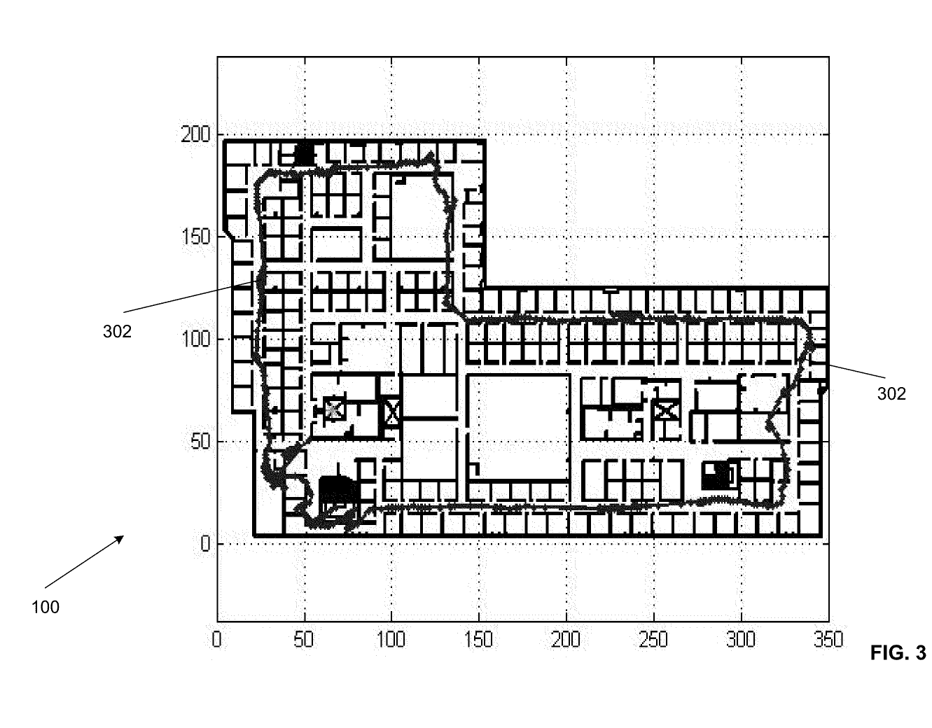

FIG. 3 illustrates an exemplary application of using positioning assistance data provided to a mobile device in the venue of FIG. 1A according to aspects of the present disclosure. In the exemplary application of FIG. 3, using the position assistance data provided as described in association with FIG. 1A-1C, a path 302 of a mobile device may be determined.

According to aspects of the present disclosure, statistical distribution of user locations may be expressed as a probability map. A probability map may comprise one or more likelihood values that correspond to one or more positions of a venue. For example, at least one likelihood value may correspond to one or more positions of the venue. A statistical distribution may, for example, indicate one or more likelihoods of being in a particular state given a previous state. A statistical distribution may be used to determine likelihood values. A likelihood value may express a likelihood, e.g. in probabilistic terms, that a mobile device is located at or is to transition to a given position based on parameters corresponding to mobile device for at least one prior epoch (e.g., at least an immediately prior epoch). Such parameters may characterize position, movement, etc. of a mobile device at an instantaneous moment or over an elapsed time period. Examples of parameters characterizing position or movement of a mobile device may include, but are not limited to, an estimated position, a speed, a direction, a trajectory over an elapsed time period, or any combination thereof, etc. By way of example only, a probability map may correspond to the venue and include multiple indications of likelihoods of mobile devices moving to or being located at various positions of the venue based on a movement or location history of a mobile device.

A mobile device may use likelihood values of a probability map, by way of example but not limitation, to establish or adjust a position fix. For example, if other positioning techniques or measured values result in a set of likely positions, the set of likely positions may be selected by identifying one or more positions in the set of likely positions having greater likelihood value(s) based at least in part on a probability map as compared to one or more other positions in the set of likely positions. For instance, a mobile device may consider a position, a direction, or a speed at a previous moment (e.g., from a previous state) in conjunction with probability map to determine one or more positions at which the mobile device is more probably positioned at a current moment (e.g., at a current state). These more probable positions that are determined at least partly based on probability map may be used to select the set of likely positions of the mobile device. Probability map may include a map of a venue to which it corresponds. Additionally or alternatively, probability map may reference positions that are defined or otherwise specified in a map that is included as part of, e.g., schematic map.

Using instantaneous positions or tracked movement parameters of mobile devices, which may be received directly from such mobile devices, a server may update a probability map to produce an updated probability map. For example, a server may adjust likelihood values of a probability map based on where mobile devices are positioned over time or how mobile devices move (e.g., how positions, velocities, trajectories, or combinations thereof, etc. change over time) in a venue. Mobile device positions may be determined, for example, using known trilateration-based techniques or using a statistical positioning model. With trilateration, for instance, a mobile device may use a mathematical formula or a look-up table that may define a functional relationship between received wireless signal characteristics (e.g., RSSI, RTT, RTD, etc.) and a range to one or more wireless transmitters. An updated probability map may be disseminated by server directly to mobile device(s) or indirectly to mobile device(s) by transmitting an updated probability map to server.

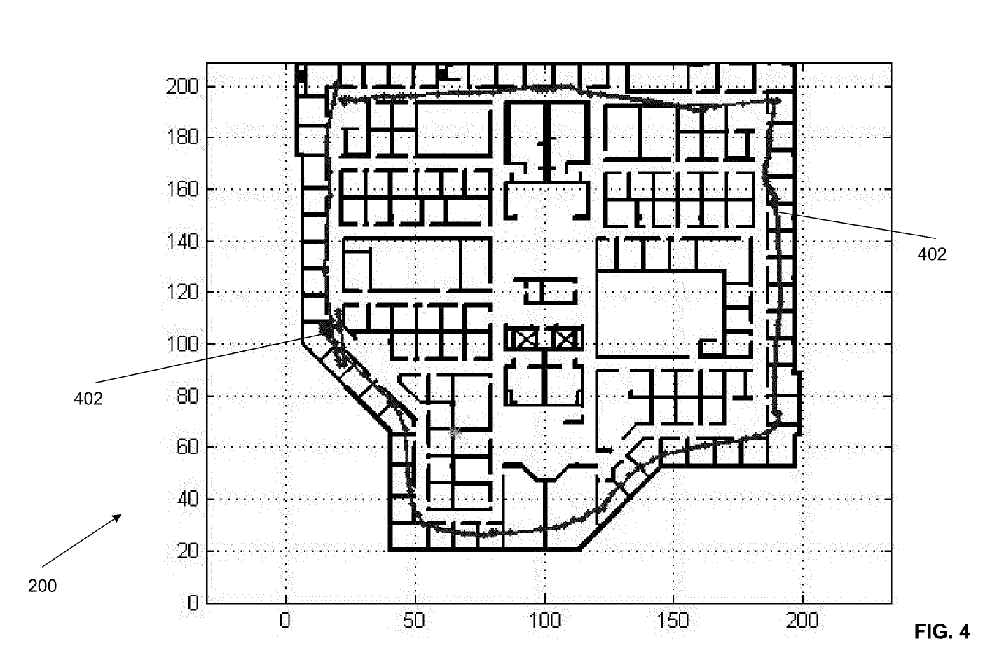

FIG. 4 illustrates another exemplary application of using positioning assistance data provided to a mobile device in the venue of FIG. 2A according to aspects of the present disclosure. In this example, using the position assistance data provided as described in association with FIG. 2A-2C, a path 402 of a mobile device may be determined.

According to aspects of the present disclosure, a venue may include one or more obstacles. Obstacles may include, but are not limited to, walls, doors, railings, or columns; furniture or cubicle dividers; elevators or stairs; or any combination thereof; etc. Obstacles may exist in the physical world and may have corresponding representation(s) included as part of a schematic map of the venue. Although claimed subject matter is not so limited, obstacles may thus include building features or other objects that may restrict movement around a venue. On the other hand, venues may also have open areas such as lobbies, common areas, entryways, or rooms, etc., just to name a few examples. Accordingly, paths of movement in such venue may be restricted in some areas (although they may also be unrestricted in other, open areas); such venue may be an example of a constrained environment.

Feasible positions of a mobile device may comprise locations of the venue. Positions may have corresponding representation(s) included as part of a schematic map of the venue. Positions may also have counterpart locations in the physical world. Positions may be defined to any level of granularity or scale. For example, positions may be one inch, one foot, or ten feet apart, just to name a few examples. Positions may also be organized or arranged in any manner. By way of example only, positions may be organized into a grid of points, which may be associated with a local or global coordinate system and laid over a floor plan or other schematic map of the venue at substantially uniform spacing. A scale of a grid of points (e.g., an interval or distance between adjacent points) may be varied based, at least in part, on a desired level of precision for positioning or other location-based services, on an available amount of resources (e.g., memory, processing, etc.), on a size of a schematic map or rooms being covered, on any combination thereof, etc. In one particular implementation, grid points may be placed or positioned at sufficiently regular intervals so as to cover, for example, at least a portion of the venue.

A range may comprise, by way of example only, a radial distance between a mobile device and a wireless transmitter/access point, with the radial distance capable of circumscribing at least a portion of a circle, such as an arc. At least one measured value (e.g., an RTT value, or an RTD value, etc.) by a mobile device with respect to e.g. a wireless transmitter may enable a mobile device to estimate a range between mobile device and wireless transmitter, as is known in the art. An RTT may be derived from, for example, one or more communication exchanges between a mobile device and one or more wireless access points in the venue.

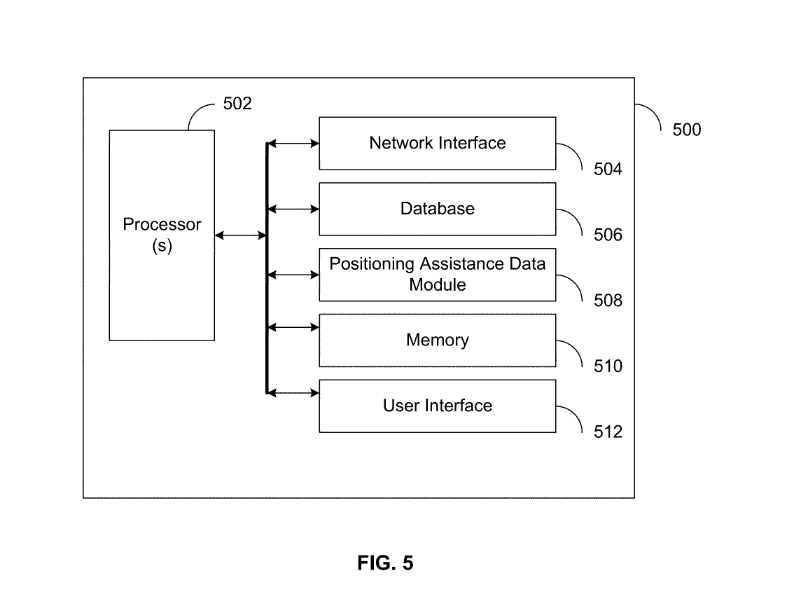

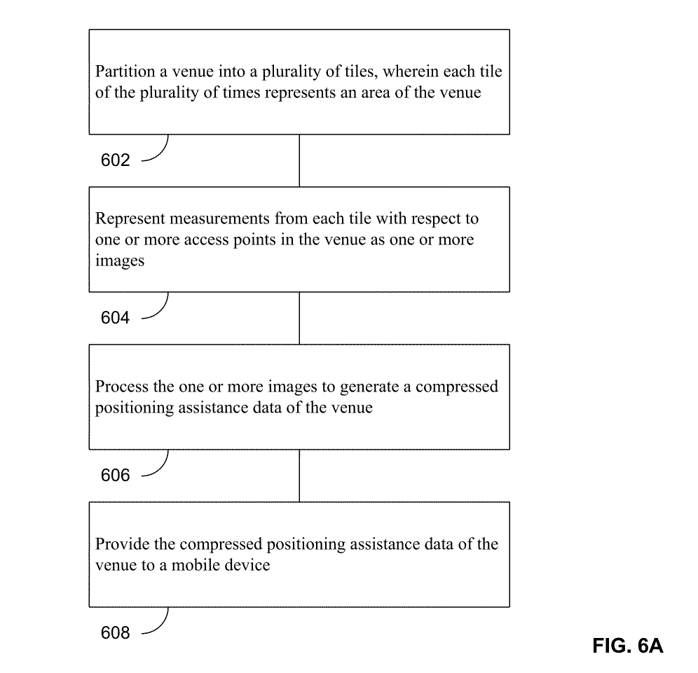

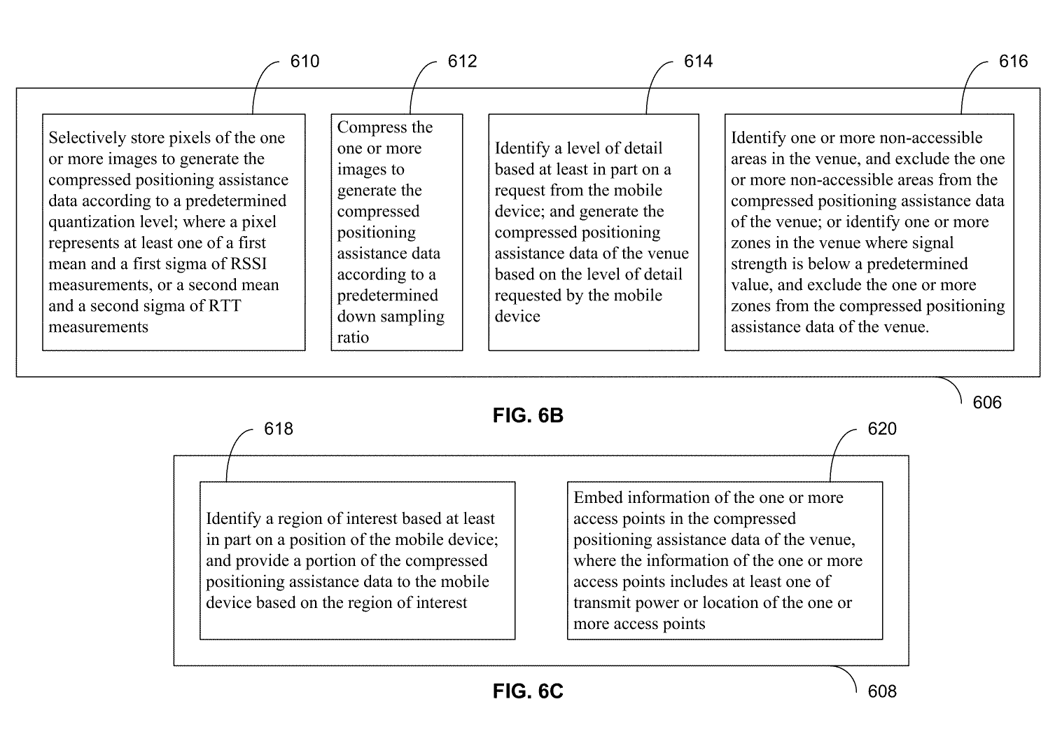

FIG. 5 illustrates an exemplary apparatus for providing positioning assistance data according to aspects of the present disclosure. In the example shown in FIG. 5, apparatus 500 includes one or more processors 502, network interface 504, database 506, positioning assistance data module 508, and memory 510. The one or more processors 502 can be configured to control operations of the apparatus 500. The network interface 504 can be configured to communicate with a network (not shown), which may be configured to communicate with servers, computers, and mobile devices on the network. Database 506 can be configured to store RSSI and RTT measurements of a venue, as well as maps, images, and other user-defined information. Positioning assistance data module 508 can be configured to implement methods of providing positioning assistance data. For example, working with the processor(s) 502, the positioning assistance data module 508 can be configured to implement methods described above and methods described below in association with FIG. 6A-6C. Memory 510 can be configured to store program codes and data for the apparatus 500. User interface 512 may be configured to enable interactions between the apparatus and a user of the apparatus. According to aspects of the present disclosure, the apparatus 500 may be implemented as a part of a server. In that implementation, the positioning assistance data may be communicated to mobile devices via the network interface 504. According to other aspects of the present disclosure, the apparatus 500 may be implemented as a part of a mobile device. In that implementation, the positioning assistance data may be used by the mobile device and/or may be communicated to other mobile devices or servers via the network interface 504. In yet other implementations, some blocks of the apparatus 500 may be implemented in a mobile device and some blocks of the apparatus 500 may be in a server. These implementations or any combinations thereof are within the scope of the present disclosure.

FIG. 6A illustrates an exemplary flow chart for implementing a method of providing positioning assistance data according to some aspects of the present disclosure. In the exemplary implementation shown in FIG. 6A, in block 602, the method partitions a venue into a plurality of tiles, where each tile in the plurality of tiles represents an area of the venue. In some embodiments, the method of partitioning the venue into a plurality of tiles may include at least one of partitioning the venue into a plurality of squares of predetermined sizes, or partitioning the venue into a plurality of hexagons of predetermined sizes.

In block 604, the method represents measurements from each tile with respect to one or more access points in the venue as one or more images. In some embodiments, the method of representing measurements from each tile with respect to one or more access points in the venue as one or more images may include at least one of representing RSSI measurements from each tile with respect to the one or more access points in the venue as a first image, or representing RTT measurements from each tile with respect to the one or more access points in the venue as a second image.

In block 606, the method processes the one or more images to generate a compressed positioning assistance data of the venue. Various methods of processing the one or more images to generate the compressed positioning assistance data of the venue are described in association with FIG. 6B below. In block 608, the method provides the compressed positioning assistance data of the venue to a mobile device. Various methods of providing the compressed positioning assistance data of the venue to a mobile device are described in association with FIG. 6C below.

According to aspects of the present disclosure, using the compressed positioning assistance data, a server or a mobile device may be configured to determine a position of the mobile device using the compressed positioning assistance data. In one particular embodiment, the server or mobile device may decode the compressed positioning assistance data of the venue to generate the positioning assistance data of the venue. It may then compare WiFi signal characteristics of the mobile device with respect to WiFi signal characteristics of a tile stored in the positioning assistance data of the venue. Using the comparison information, the server or mobile device may determine the position of the mobile device based at least in part on a closest match of the WiFi signal characteristics being compared. Note that the method may reconstruct the positioning assistance data of the venue based on at least a method of bilinear interpolation, bicubic interpolation, or antialiasing interpolation.

According to aspects of the present disclosure, the image data may be delivered between a server and one or more mobile devices (also referred to as mobile clients) interactively in segments. Such data deliver may be performed in an arbitrary order in response to real-time mobile client requests. In one particular embodiment, these requests may be in the form of view-window requests and may correspond to user actions like zooming and panning. The disclosed method or apparatus may implement a resolution hierarchy scheme to minimize the redundant retransmission of image data and to circumvent the need for storing multiple versions of an image at different resolutions. In addition, the disclosed method or apparatus can enable scalability with respect to different defined image progression orders, and be able to convert between different progression orders by using systematic reordering of packets, without any low-level decoding. The disclosed method or apparatus may also be configured to support communication of capabilities and limitations of the mobile clients. A mobile client may request information, such as Metadata, about an image, which enables the mobile client to refine its requests to image specific parameters, for example the transmit power of the one or more access points.

According to aspects of the present disclosure, a mobile client may formulate requests using a descriptive syntax which identifies the current image window of the mobile client's application. The disclosed method or apparatus may be configured to support interactive imaging, with fewer round-trip delays. The disclosed method or apparatus may use requests from the mobile client to identify the mobile client's spatial region of interest, resolution and image components of interest. It may then determine the most appropriate response elements and to optimally sequence them. In addition, the disclosed method or apparatus may be configured to adjust the sequence in which image data may be returned so as to minimize disk thrashing while optimizing the image quality available at the mobile client. A single request can be sufficient to obtain an arbitrary region of an image, at a selected size/resolution, so that the mobile client requests can be embedded as static targets within HTML pages. For interactive applications, multiple mobile client requests can be issued and efficiently served within an interactive browsing session, thus avoiding the delivery of redundant data.

FIG. 6B illustrates exemplary methods of processing one or more images to generate a compressed positioning assistance data of a venue according to aspects of the present disclosure. According to some aspects of the present disclosure, the methods performed in block 606 may further include methods performed in blocks 610-616. In block 610, the method selectively stores pixels of the one or more images to generate the compressed positioning assistance data according to a predetermined quantization level, where a pixel represents at least one of a first mean and a first sigma of RSSI measurements, or a second mean and a second sigma of RTT measurements.

In block 612, the method compresses the one or more images to generate the compressed positioning assistance data according to a predetermined down sampling ratio. In block 614, the method identifies a level of detail based at least in part on a request from the mobile device, and generates the compressed positioning assistance data of the venue based on the level of detail requested by the mobile device. For example, in a particular embodiment, if a positioning system is set to operate in a low-accuracy mode, then the positioning engine may elect to use heatmaps with a lower level of detail. In this case, the reduced level of detail heatmap may be extracted by the imaging codec without having to decode all levels of detail. In the case where the heatmaps may be downloaded from a server, the heatmaps may be streamed to a mobile device in increasing levels of detail, such as in a manner of progressive download.

In block 616, the method identifies one or more non-accessible areas in a venue, and excludes the one or more non-accessible areas from the compressed positioning assistance data of the venue. Additionally and/or alternatively, the method identifies one or more zones in the venue where signal strength is below a predetermined value, and excludes the one or more zones from the compressed positioning assistance data of the venue. For example, in a particular embodiment, transparency and alpha planes may be used to encode accessible/non-accessible areas of a floor plan, as well as to encode masks of areas where signal strengths of given APs may be below a predetermined value (e.g. −80 dB).

FIG. 6C illustrates exemplary methods of providing the compressed positioning assistance data of a venue to a mobile device according to aspects of the present disclosure. In some embodiments, the methods performed in block 608 may further include methods performed in blocks 618-620. In block 618, the method identifies a region of interest based at least in part on a position of the mobile device, and provides a portion of the compressed positioning assistance data to the mobile device based on the region of interest. For example, in a particular embodiment, if the assistance data covers a large physical area of a venue and only a portion of it is needed for operation of the positioning engine, a sub-region can be decoded without having to decode the entire image.

In block 620, the method embeds information of the one or more access points in the compressed positioning assistance data of the venue. The information of the one or more access points may include at least one of the transmit power or location of the one or more access points. For example, in a particular embodiment, any arbitrary metadata can be embedded in an image file in XML form. In one approach, in the case of a heatmap for a specific AP, details regarding the AP, such as channel, capabilities, latitude-longitude-altitude location, transmit power, may be embedded in the positioning assistance data of the venue.

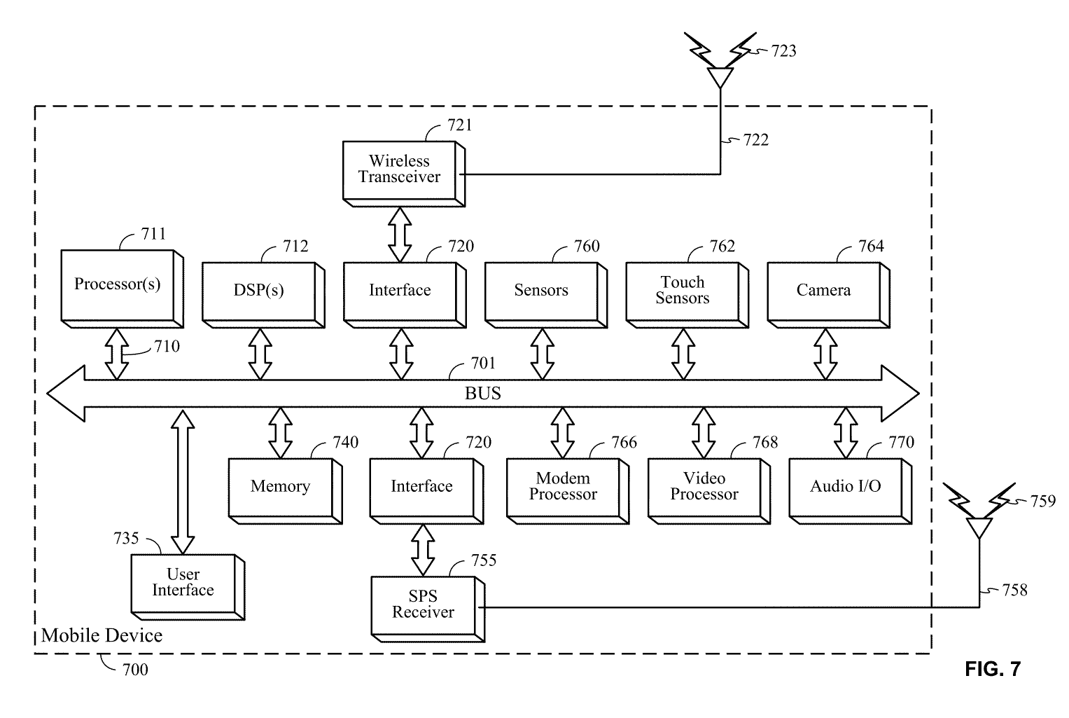

FIG. 7 illustrates an exemplary block diagram of a mobile device according to aspects of the present disclosure. As shown in FIG. 7, mobile device 700 may comprise one or more features of the one or more mobile devices as described in association with FIG. 3, FIG. 4, FIG. 5 and FIG. 6A-6B. In certain embodiments, mobile device 700 may also comprise a wireless transceiver 721 which is capable of transmitting and receiving wireless signals 723 via wireless antenna 722 over a wireless communication network. Wireless transceiver 721 may be connected to bus 701 by a wireless transceiver bus interface 720. Wireless transceiver bus interface 720 may, in some embodiments be at least partially integrated with wireless transceiver 721. Some embodiments may include multiple wireless transceivers 721 and wireless antennas 722 to enable transmitting and/or receiving signals according to a corresponding multiple wireless communication standards such as, for example, versions of IEEE Std. 802.11, CDMA, WCDMA, LTE, UMTS, GSM, AMPS, Zigbee and Bluetooth®, etc.

According to aspects of the present disclosure, wireless transceiver 721 may comprise a transmitter and a receiver. The transmitter and the receiver may be implemented to share common circuitry, or may be implemented as separate circuits. Mobile device 700 may also comprise SPS receiver 755 capable of receiving and acquiring SPS signals 759 via SPS antenna 758. SPS receiver 755 may also process, in whole or in part, acquired SPS signals 759 for estimating a location of mobile device 700. In some embodiments, processor(s) 711, memory 740, DSP(s) 712 and/or specialized processors (not shown) may also be utilized to process acquired SPS signals, in whole or in part, and/or calculate an estimated location of mobile device 700, in conjunction with SPS receiver 755. Storage of SPS or other signals for use in performing positioning operations may be performed in memory 740 or registers (not shown).

Also shown in FIG. 7, mobile device 700 may comprise digital signal processor(s) (DSP(s)) 712 connected to the bus 701 by a bus interface 710, processor(s) 711 connected to the bus 701 by a bus interface 710 and memory 740. Bus interface 710 may be integrated with the DSP(s) 712, processor(s) 711 and memory 740. In various embodiments, functions may be performed in response execution of one or more machine-readable instructions stored in memory 740 such as on a computer-readable storage medium, such as RAM, ROM, FLASH, or disc drive, just to name a few example. The one or more instructions may be executable by processor(s) 711, specialized processors, or DSP(s) 712. Memory 740 may comprise a non-transitory processor-readable memory and/or a computer-readable memory that stores software code (programming code, instructions, etc.) that are executable by processor(s) 711 and/or DSP(s) 712 to perform functions described herein. In a particular implementation, wireless transceiver 721 may communicate with processor(s) 711 and/or DSP(s) 712 through bus 701 to enable mobile device 700 to be configured as a wireless mobile device as discussed above. Processor(s) 711 and/or DSP(s) 712 may execute instructions to execute one or more aspects of processes/methods discussed above in connection with FIG. 6A-6C.

Also shown in FIG. 7, a user interface 735 may comprise any one of several devices such as, for example, a speaker, microphone, display device, vibration device, keyboard, touch screen, etc. In a particular implementation, user interface 735 may enable a user to interact with one or more applications hosted on mobile device 700. For example, devices of user interface 735 may store analog or digital signals on memory 740 to be further processed by DSP(s) 712 or processor 711 in response to action from a user. Similarly, applications hosted on mobile device 700 may store analog or digital signals on memory 740 to present an output signal to a user. In another implementation, mobile device 700 may optionally include a dedicated audio input/output (I/O) device 770 comprising, for example, a dedicated speaker, microphone, digital to analog circuitry, analog to digital circuitry, amplifiers and/or gain control. In another implementation, mobile device 700 may comprise touch sensors 762 responsive to touching or pressure on a keyboard or touch screen device.

Mobile device 700 may also comprise a dedicated camera device 764 for capturing still or moving imagery. Dedicated camera device 764 may comprise, for example an imaging sensor (e.g., charge coupled device or CMOS imager), lens, analog to digital circuitry, frame buffers, etc. In one implementation, additional processing, conditioning, encoding or compression of signals representing captured images may be performed at processor 711 or DSP(s) 712. Alternatively, a dedicated video processor 768 may perform conditioning, encoding, compression or manipulation of signals representing captured images. Additionally, dedicated video processor 768 may decode/decompress stored image data for presentation on a display of mobile device 700.

Mobile device 700 may also comprise sensors 760 coupled to bus 701 which may include, for example, inertial sensors and environment sensors. Inertial sensors of sensors 760 may comprise, for example accelerometers (e.g., collectively responding to acceleration of mobile device 700 in three dimensions), one or more gyroscopes or one or more magnetometers (e.g., to support one or more compass applications). Environment sensors of mobile device 700 may comprise, for example, temperature sensors, barometric pressure sensors, ambient light sensors, and camera imagers, microphones, just to name few examples. Sensors 760 may generate analog or digital signals that may be stored in memory 740 and processed by DPS(s) or processor 711 in support of one or more applications such as, for example, applications directed to positioning or navigation operations.

In a particular implementation, mobile device 700 may comprise a dedicated modem processor 766 capable of performing baseband processing of signals received and down-converted at wireless transceiver 721 or SPS receiver 755. Similarly, dedicated modem processor 766 may perform baseband processing of signals to be up-converted for transmission by wireless transceiver 721. In alternative implementations, instead of having a dedicated modem processor, baseband processing may be performed by a processor or DSP (e.g., processor 711 or DSP(s) 712).

Note that at least the following three paragraphs, FIG. 1A-1C, FIG. 2A-2C, FIG. 3-FIG. 5, FIG. 6A and their corresponding descriptions provide means for partitioning a venue into a plurality of tiles, where each tile in the plurality of tiles represents an area of the venue; means for representing measurements from each tile with respect to one or more access points in the venue as one or more images; means for processing the one or more images to generate a compressed positioning assistance data of the venue; means for providing the compressed positioning assistance data of the venue to a mobile device; means for representing RSSI measurements from each tile with respect to the one or more access points in the venue as a first image; means for representing RTT measurements from each tile with respect to the one or more access points in the venue as a second image. Note that at least the following three paragraphs, FIG. 5, FIG. 6B-6C, FIG. 7 and their corresponding descriptions provide means for selectively storing pixels of the one or more images to generate the compressed positioning assistance data of the venue according to a predetermined quantization level; means for compressing the one or more images to generate the compressed positioning assistance data of the venue according to a predetermined down sampling ratio; means for identifying a level of detail based at least in part on a request from the mobile device; and means for generating the compressed positioning assistance data of the venue based on the level of detail requested by the mobile device; means for identifying one or more non-accessible areas in the venue, and means for excluding the one or more non-accessible areas from the compressed positioning assistance data of the venue; means for identifying one or more zones in the venue where signal strength is below a predetermined value, and means for excluding the one or more zones from the compressed positioning assistance data of the venue; means for identifying a region of interest based at least in part on a position of the mobile device; and means for providing a portion of the compressed positioning assistance data to the mobile device based on the region of interest.

The methodologies, apparatus and mobile device described herein can be implemented by various means depending upon the application. For example, these methodologies can be implemented in hardware, firmware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof. Herein, the term “processing logic” or “control logic” encompasses logic implemented by software, hardware, firmware, or a combination.

For a firmware and/or software implementation, the methodologies can be implemented with modules (e.g., procedures, functions, and so on) that perform the functions described herein. Any machine readable medium tangibly embodying instructions can be used in implementing the methodologies described herein. For example, software codes can be stored in a memory and executed by a processing unit. Memory can be implemented within the processing unit or external to the processing unit. As used herein the term “memory” refers to any type of long term, short term, volatile, nonvolatile, or other storage devices and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media may take the form of an article of manufacturer. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause at least one processor to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The disclosure may be implemented in conjunction with various wireless communication networks such as a wireless wide area network (WWAN), a wireless local area network (WLAN), a wireless personal area network (WPAN), and so on. The terms “network” and “system” are often used interchangeably. The terms “position” and “location” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network and so on. A CDMA network may implement one or more radio access technologies (RATs) such as cdma2000, Wideband-CDMA (WCDMA), and so on. Cdma2000 includes IS-95, IS2000, and IS-856 standards. A TDMA network may implement Global System for Mobile Communications (GSM), Digital Advanced Mobile Phone System (D-AMPS), or some other RAT. GSM and WCDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth® network, an IEEE 802.15x, or some other type of network. The techniques may also be implemented in conjunction with any combination of WWAN, WLAN and/or WPAN.

A mobile station refers to a device such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile station” is also intended to include devices which communicate with a personal navigation device (PND), such as by short-range wireless, infrared, wire line connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile station.”

Designation that something is “optimized,” “required” or other designation does not indicate that the current disclosure applies only to systems that are optimized, or systems in which the “required” elements are present (or other limitation due to other designations). These designations refer only to the particular described implementation. Of course, many implementations are possible. The techniques can be used with protocols other than those discussed herein, including protocols that are in development or to be developed.

One skilled in the relevant art will recognize that many possible modifications and combinations of the disclosed embodiments may be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations are possible in view of the above teachings. The embodiments were chosen and described to explain the principles of the disclosure and their practical applications, and to enable others skilled in the art to best utilize the disclosure and various embodiments with various modifications as suited to the particular use contemplated.

We claim:

1. A method of providing positioning assistance data, comprising:
partitioning a venue into a plurality of tiles, wherein each tile in the plurality of tiles represents an area of the venue;
representing measurements from each tile with respect to one or more access points in the venue as one or more images;
processing the one or more images to generate a compressed positioning assistance data of the venue; and
providing the compressed positioning assistance data of the venue to a mobile device.

2. The method of claim 1, wherein the representing measurements from each tile with respect to the one or more access points in the venue as the one or more images comprises at least one of:
representing RSSI measurements from each tile with respect to the one or more access points in the venue as a first image; or
representing RTT measurements from each tile with respect to the one or more access points in the venue as a second image.

3. The method of claim 1, wherein the processing the one or more images to generate the compressed positioning assistance data of the venue comprises:
selectively storing pixels of the one or more images to generate the compressed positioning assistance data of the venue according to a predetermined quantization level; wherein a pixel represents at least one of a first mean and a first sigma of RSSI measurements, or a second mean and a second sigma of RTT measurements.

4. The method of claim 1, wherein the processing the one or more images to generate the compressed positioning assistance data of the venue further comprises:
compressing the one or more images to generate the compressed positioning assistance data of the venue according to a predetermined down sampling ratio.

5. The method of claim 1, wherein the processing the one or more images to generate the compressed positioning assistance data of the venue further comprises:
identifying a level of detail based at least in part on a request from the mobile device; and
generating the compressed positioning assistance data of the venue based on the level of detail requested by the mobile device.

6. The method of claim 1, wherein the processing the one or more images to generate the compressed positioning assistance data of the venue further comprises at least one of:
identifying one or more non-accessible areas in the venue, and excluding the one or more non-accessible areas from the compressed positioning assistance data of the venue; or
identifying one or more zones in the venue where signal strength is below a predetermined value, and excluding the one or more zones from the compressed positioning assistance data of the venue.

7. The method of claim 1, wherein the providing the compressed positioning assistance data of the venue to the mobile device comprises:
identifying a region of interest based at least in part on a position of the mobile device; and
providing a portion of the compressed positioning assistance data to the mobile device based on the region of interest.

8. The method of claim 1, wherein the providing the compressed positioning assistance data of the venue to the mobile device further comprises:
embedding information of the one or more access points in the compressed positioning assistance data of the venue, wherein the information of the one or more access points includes at least one of transmit power or location of the one or more access points.

9. An apparatus, comprising:
a positioning data assistance module and a processor, including processing logic, the processing logic comprising:
logic configured to partition a venue into a plurality of tiles, wherein each tile in the plurality of tiles represents an area of the venue;
logic configured to represent measurements from each tile with respect to one or more access points in the venue as one or more images;
logic configured to process the one or more images to generate a compressed positioning assistance data of the venue; and
logic configured to provide the compressed positioning assistance data of the venue to a mobile device.

10. The apparatus of claim 9, wherein the logic configured to represent measurements from each tile with respect to the one or more access points in the venue as the one or more images comprises at least one of:
logic configured to represent RSSI measurements from each tile with respect to the one or more access points in the venue as a first image; or
logic configured to represent RTT measurements from each tile with respect to the one or more access points in the venue as a second image.

11. The apparatus of claim 9, wherein the logic configured to process the one or more images to generate the compressed positioning assistance data of the venue comprises:
logic configured to selectively store pixels of the one or more images to generate the compressed positioning assistance data of the venue according to a predetermined quantization level; wherein a pixel represents at least one of a first mean and a first sigma of RSSI measurements, or a second mean and a second sigma of RTT measurements.

12. The apparatus of claim 9, wherein the logic configured to process the one or more images to generate the compressed positioning assistance data of the venue further comprises:
logic configured to compress the one or more images to generate the compressed positioning assistance data of the venue according to a predetermined down sampling ratio.

13. The apparatus of claim 9, wherein the logic configured to process the one or more images to generate the compressed positioning assistance data of the venue further comprises:
logic configured to identify a level of detail based at least in part on a request from the mobile device; and
logic configured to generate the compressed positioning assistance data of the venue based on the level of detail requested by the mobile device.

14. The apparatus of claim 9, wherein the logic configured to process the one or more images to generate the compressed positioning assistance data of the venue further comprises at least one of:
logic configured to identify one or more non-accessible areas in the venue, and logic configured to exclude the one or more non-accessible areas from the compressed positioning assistance data of the venue; or
logic configured to identify one or more zones in the venue where signal strength is below a predetermined value, and logic configured to exclude the one or more zones from the compressed positioning assistance data of the venue.

15. The apparatus of claim 9, wherein the logic configured to provide the compressed positioning assistance data of the venue to the mobile device comprises:
logic configured to identify a region of interest based at least in part on a position of the mobile device; and
logic configured to provide a portion of the compressed positioning assistance data to the mobile device based on the region of interest.

16. The apparatus of claim 9, wherein the logic configured to provide the compressed positioning assistance data of the venue to the mobile device further comprises:
logic configured to embed information of the one or more access points in the compressed positioning assistance data of the venue, wherein the information of the one or more access points includes at least one of transmit power or location of the one or more access points.

17. A computer program product comprising non-transitory medium storing instructions for execution by one or more computer systems, the instructions comprising:
instructions for partitioning a venue into a plurality of tiles, wherein each tile in the plurality of tiles represents an area of the venue;
instructions for representing measurements from each tile with respect to one or more access points in the venue as one or more images;
instructions for processing the one or more images to generate a compressed positioning assistance data of the venue; and
instructions for providing the compressed positioning assistance data of the venue to a mobile device.

18. The computer program product of claim 17, wherein the instructions for representing measurements from each tile with respect to the one or more access points in the venue as the one or more images comprises at least one of:
instructions for representing RSSI measurements from each tile with respect to the one or more access points in the venue as a first image; or
instructions for representing RTT measurements from each tile with respect to the one or more access points in the venue as a second image.

19. The computer program product of claim 17, wherein the instructions for processing the one or more images to generate the compressed positioning assistance data of the venue comprises:
instructions for selectively storing pixels of the one or more images to generate the compressed positioning assistance data of the venue according to a predetermined quantization level; wherein a pixel represents at least one of a first mean and a first sigma of RSSI measurements, or a second mean and a second sigma of RTT measurements.

20. The computer program product of claim 17, wherein the instructions for processing the one or more images to generate the compressed positioning assistance data of the venue further comprises:
instructions for compressing the one or more images to generate the compressed positioning assistance data of the venue according to a predetermined down sampling ratio.

21. The computer program product of claim 17, wherein the instructions for processing the one or more images to generate the compressed positioning assistance data of the venue further comprises:
instructions for identifying a level of detail based at least in part on a request from the mobile device; and
instructions for generating the compressed positioning assistance data of the venue based on the level of detail requested by the mobile device.

22. The computer program product of claim 17, wherein the instructions for processing the one or more images to generate the compressed positioning assistance data of the venue further comprises at least one of:
instructions for identifying one or more non-accessible areas in the venue, and instructions for excluding the one or more non-accessible areas from the compressed positioning assistance data of the venue; or
instructions for identifying one or more zones in the venue where signal strength is below a predetermined value, and instructions for excluding the one or more zones from the compressed positioning assistance data of the venue.

23. The computer program product of claim 17, wherein the instructions for providing the compressed positioning assistance data of the venue to the mobile device comprises:
instructions for identifying a region of interest based at least in part on a position of the mobile device; and
instructions for providing a portion of the compressed positioning assistance data to the mobile device based on the region of interest.

24. An apparatus, comprising:
means for partitioning a venue into a plurality of tiles, wherein each tile in the plurality of tiles represents an area of the venue;
means for representing measurements from each tile with respect to one or more access points in the venue as one or more images;
means for processing the one or more images to generate a compressed positioning assistance data of the venue; and
means for providing the compressed positioning assistance data of the venue to a mobile device.

25. The apparatus of claim 24, wherein the means for representing measurements from each tile with respect to the one or more access points in the venue as the one or more images comprises at least one of:
means for representing RSSI measurements from each tile with respect to the one or more access points in the venue as a first image; or
means for representing RTT measurements from each tile with respect to the one or more access points in the venue as a second image.

26. The apparatus of claim 24, wherein the means for processing the one or more images to generate the compressed positioning assistance data of the venue comprises:
means for selectively storing pixels of the one or more images to generate the compressed positioning assistance data of the venue according to a predetermined quantization level; wherein a pixel represents at least one of a first mean and a first sigma of RSSI measurements, or a second mean and a second sigma of RTT measurements.

27. The apparatus of claim 24, wherein the means for processing the one or more images to generate the compressed positioning assistance data of the venue further comprises:
means for compressing the one or more images to generate the compressed positioning assistance data of the venue according to a predetermined down sampling ratio.

28. The apparatus of claim 24, wherein the means for processing the one or more images to generate the compressed positioning assistance data of the venue further comprises:
means for identifying a level of detail based at least in part on a request from the mobile device; and
means for generating the compressed positioning assistance data of the venue based on the level of detail requested by the mobile device.

29. The apparatus of claim 24, wherein the means for processing the one or more images to generate the compressed positioning assistance data of the venue further comprises at least one of:
means for identifying one or more non-accessible areas in the venue, and means for excluding the one or more non-accessible areas from the compressed positioning assistance data of the venue; or
means for identifying one or more zones in the venue where signal strength is below a predetermined value, and means for excluding the one or more zones from the compressed positioning assistance data of the venue.

30. The apparatus of claim 24, wherein the means for providing the compressed positioning assistance data of the venue to the mobile device comprises:
means for identifying a region of interest based at least in part on a position of the mobile device; and
means for providing a portion of the compressed positioning assistance data to the mobile device based on the region of interest.
